(19) United States
(12) Patent Application Publication
(10) Pub. No.: US 2025/0020307 A1
(43) Pub. Date: Jan. 16, 2025

(54) DECORATIVE ARTICLE AND METHOD FOR MANUFACTURING THEREOF

(71) Applicant: PETER WAYNE YENAWINE, BETHLEHEM, PA (US)

(72) Inventor: PETER WAYNE YENAWINE, BETHLEHEM, PA (US)

(21) Appl. No.: 18/222,462

(22) Filed: Jul. 16, 2023

(51) Int. Cl. F21V 3/02; F21S 10/06; F21V 3/06; F21V 33/00; H05B 47/12

(52) U.S. Cl. CPC F21V 3/02; F21S 10/063; F21V 3/061; F21V 33/0056; H05B 47/12; F21W 2121/02; F21Y 2115/10

(57) ABSTRACT

Disclosed is a decorative article (100). The decorative article (100) includes a plurality of branches (102a-102n) such that each branch of the plurality of branches (102a-102n) comprising a first end (108). The decorative article (100) further includes a plurality of illuminating sources (104a-104n) such that each illuminating source of the plurality of illuminating sources (104a-104n) is disposed at the first end (108). One illuminating source of the plurality of illuminating sources (104a-104n) is having a different color from another illuminating source of the plurality of the illuminating sources (104a-104n). Each illuminating source of the plurality of illuminating sources (104a-104n) is adapted to illuminate corresponding branch of the plurality of branches (102a-102n).

### TECHNICAL FIELD

The present disclosure generally relates to decor. More particularly, the present disclosure relates to a decorative article and a method for manufacturing thereof.

### BACKGROUND

Artwork and decorative articles in various locations, specifically, interiors of homes and offices are widely used. The decorative articles in various forms, provide a pleasing visual display to enhance a visitor's experience for certain facilities such as, a saloon, an amusement park, and a restaurant. Water displays aid fountains are most popular decorative article. The fountain based decorative article generally uses water to replicate the original water spurts. Water is usually transported from an upper level to a lower level.

The artwork and decorative articles are displayed and they are prone to get damaged. Damage to the decorative article adversely affects their aesthetics and beauty. Further, designing various kinds of artwork that resembles a real structure is difficult. Designing of the artwork requires substantial due diligence. Further, in fountain based decorative articles, issues lie in having a continuous water supply. The water needs to be continuously supplied, which causes issues of replenishment. Sometimes, water may spill over from the decorative article towards the ambient public that is standing nearby. This may cause an awkward situation for the public and may provoke them to leave the facility, where the decorative article is placed.

The above-mentioned limitations of the conventional decorative article would restrict the commercial deployment of the decorative articles. In an attempt to scale up the use of decorative articles, there remains a need for a decorative article that is capable of solving the aforementioned problems of the conventional decorative articles.

### SUMMARY

In view of the foregoing, a decorative article is disclosed. The decorative article includes a plurality of branches such that each branch of the plurality of branches includes a first end. The decorative article further includes a plurality of illuminating sources such that each illuminating source of the plurality of illuminating sources is disposed at the first end. One illuminating source of the plurality of illuminating sources is having a different color from another illuminating source of the plurality of the illuminating sources. Each illuminating source of the plurality of illuminating sources is adapted to illuminate corresponding branch of the plurality of branches.

In some aspects of the present disclosure, each branch of the plurality of branches further includes a second end that is disposed spaced apart from the first end such that the second end of a set of branches of the plurality of branches is split into one or more nodes.

In some aspects of the present disclosure, the decorative article further includes a base portion such that the first end is coupled to the base portion. The base portion is glued to a low iron plate glass.

In some aspects of the present disclosure, the decorative article further includes a motor adapted to provide a rotational force. The decorative article further includes an actuator disposed on the base portion and coupled to the motor such that the actuator rotates, in response to the rotational force provided by the motor, the base portion.

In some aspects of the present disclosure, each branch of the plurality of branches has a length such that the length of one branch of the plurality of branches is different from the length of another branch of the plurality of branches.

In some aspects of the present disclosure, upon illumination of each branch of the plurality of branches, light traverses from the first end to the second end.

In some aspects of the present disclosure, the decorative article is a waterless fountain.

In some aspects of the present disclosure, each branch of the plurality of branches is made up of a freeform glass.

In some aspects of the present disclosure, each illuminating source of the plurality of illuminating sources is a light emitting diode (LED).

In some aspects of the present disclosure, the decorative article further includes a sound sensor that is coupled to the plurality of illuminating sources. The sound sensor is configured to sense a first set of signals representing a first set of sounds. Upon sensing the first set of sounds, each illuminating source of the plurality of illuminating sources facilitates one of (i) illuminating of the corresponding branch of the plurality of branches and (ii) darkening of the corresponding branch of the plurality of branches.

In some aspects of the present disclosure, a speaker that is coupled to the sound sensor. The sound sensor is configured to sense a second set of signals representing a second set of sounds, wherein upon sensing the second set of sounds, the speaker produces a musical chime.

In some aspects of the present disclosure, the first set of sounds comprise one of, sounds produced by clapping gestures by a user and sounds produced by finger pinching gestures by the user.

In some aspects of the present disclosure, the second set of sounds comprise one or more vocal sounds produced by the user.

In some aspects of the present disclosure, a method for manufacturing a decorative article. The method includes forming each branch of the plurality of branches such that each branch of the plurality of branches includes a first end. The method further includes cutting the first end of each branch of the plurality of branches. The method further includes grinding the first end of each branch of the plurality of branches. The method further includes polishing the first end of each branch of the plurality of branches. The method further includes disposing of a plurality of illuminating sources at the first end. One illuminating source of the plurality of illuminating sources is having a different color from another illuminating source of the plurality of the illuminating sources. Each illuminating source of the plurality of illuminating sources is adapted to illuminate corresponding branch of the plurality of branches.

Various objects, features, aspects, and advantages of the present invention will become more apparent from the following detailed description of the embodiments of the invention, along with the accompanying drawings in which like numerals represent like components.

### BRIEF DESCRIPTION OF THE DRAWINGS

Having thus described the disclosure in general terms, reference will now be made to the accompanying figures, wherein:

FIG. 1 illustrates a perspective view of a decorative article, according to an aspect of the present disclosure;

FIG. 2 illustrates a perspective view of the bottom of the decorative article of FIG. 1, according to an aspect of the present disclosure;

FIG. 3 illustrates a front view of a branch of the decorative article of FIG. 1, according to an aspect of the present disclosure; and

FIG. 4 illustrates a flowchart depicting a method for manufacturing the decorative article of FIG. 1, according to an aspect of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

Before describing the present invention in detail, it should be observed that the present invention utilizes a combination of components or processes, which constitutes a decorative article and method for manufacturing thereof. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods and systems similar or equivalent to those described herein can be used in the practice or testing of embodiments, the preferred methods and systems are now described. The disclosed embodiments are merely exemplary.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation.

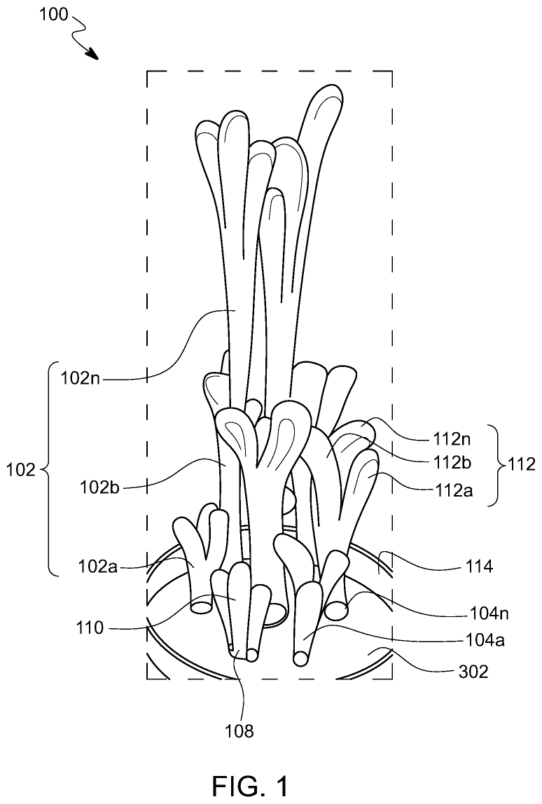

The decorative article and the method for manufacturing thereof will now be described with reference to the accompanying drawings, particularly FIGS. 1-4.

FIG. 1 illustrates a perspective view of a decorative article 100, according to an aspect of the present disclosure. The decorative article 100 may be easy to manufacture and may be easily carried from one place to another. In some aspects of the present disclosure, the decorative article 100 may be made up from a solid material that may prevent any damage of the decorative article 100. The decorative article 100 may be used in a healing garden, a rehabilitation center, a hospital, a university, a college, a school, or in a doctor's home as a sculptural work of art and the like. The decorative article 100 may facilitate fast healing of patients in the healing garden, in the hospital, and in the rehabilitation center. Embodiments of the present disclosure are intended to include and/or otherwise cover almost all the premises where the decorative article 100 may be used, without deviating from the scope of the present disclosure.

The decorative article 100 may include a plurality of branches 102a-102n (hereinafter collectively referred to and designated as “the branches 102”), a plurality of illuminating sources 104a-104n (hereinafter collectively referred to and designated as “the illuminating sources 104”), and a base portion 106. Each branch of the branches 102 may include a first end 108 and a second end 110.

Each branch of the branches 102 may have a length such that the length of one branch of the branches 102 may be different from the length of another branch of the branches 102. Each branch of the branches 102 may be made up of a material, including but not limited to, freeform glass. Embodiments of the present disclosure are intended to include and/or otherwise cover any type of known and later developed material for each branch of the branches 102, without deviating from the scope of the present disclosure.

The second end 110 may be disposed spaced apart from the first end 108. The second end 110 of a set of branches of the branches 102 may be split into one or more nodes 112a-112c (hereinafter collectively referred to and designated as “the nodes 112”).

In some aspects of the present disclosure, each node of the nodes 112 may have a flat curved profile. Aspects of the present disclosure are intended to include and/or otherwise cover any shape/profile of each node of the nodes 112, without deviating from the scope of the present disclosure.

Each illuminating source of the illuminating sources 104 may be disposed at the first end 108. Each illuminating source of the illuminating sources 104 may have a different color from each other. For example, one illuminating source of the illuminating sources 104 may have a different color from another illuminating source of the illuminating sources 104. Each illuminating source of the illuminating sources 104 may be adapted to illuminate corresponding branch of the branches 102. Specifically, upon illumination of each branch of the branches 102, a light may traverse from the first end 108 to the second end 110. Each branch of the branches 102, upon illumination, may reflect light therein, which may enhance morale of the patients in the hospital, in the rehabilitation center, and in the healing garden.

In some aspects, each illuminating source of the illuminating sources 104 may be a light emitting diode (LED).

In some aspects of the present disclosure, the decorative article 100 may be a waterless fountain. Each branch of the branches 102 may showcase a spurt upon illumination by way of the corresponding illuminating source of the illuminating sources 104. The branches 102, when considered together, may showcase multiple spurts upon illumination by way of the illuminating sources 104. In the hospital, the healing garden, and the rehabilitation center, actual water may not be used, therefore, the waterless fountain may be easily deployed therein. Because of the growth of holistic medicine, there are numerous reports that our western style of medicine is being supplemented by a variety of holistic techniques. Holistic techniques traditionally use water for healing so this waterless fountain can solve the problem of not being able to have running water in a hospital or medical environment.

The base portion 106 may be disposed at the bottom of the decorative article 100. The base portion 106 may be confined by a rim 114. In other words, the rim 114 may extend along a periphery of the base portion 106. The rim 114 may be a protrusion that may extend upwardly from and around the periphery of the base portion 106. The rim 114 may facilitate to easily hold the decorative article 100, while carrying the decorative article 100 from one place to another. The first end 108 may be coupled to the base portion 106. In other words, each branch of the branches 102 may originate from the base portion 106 such that the first end 108 lies towards the base portion 106 and the second end 110 lies away from the base portion 106.

In some aspects of the present disclosure, the base portion 106 may have a cross-sectional shape, including but not limited to, a circle, a square, a rectangle, and the like. Aspects of the present disclosure are intended to include and/or otherwise cover any cross-sectional shape, without deviating from the scope of the present disclosure.

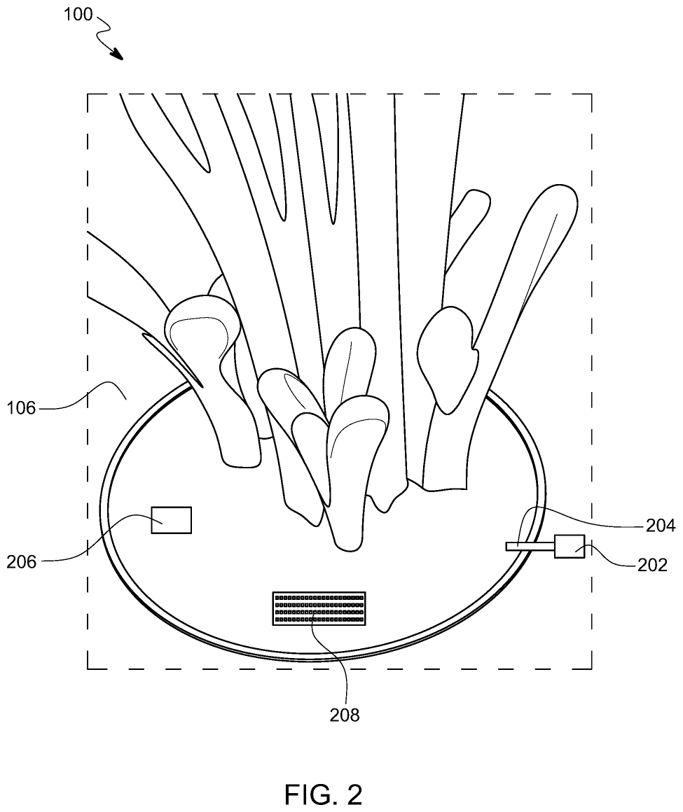

FIG. 2 illustrates a perspective view of the bottom of the decorative article 100 of FIG. 1, according to an aspect of the present disclosure. The decorative article 100 may further include a motor 202, an actuator 204, a sound sensor 206, and a speaker 208. For sake of brevity, not all the elements are referred as being already referred in FIG. 1.

The motor 202 may be disposed on the base portion 106. The motor 202 may be adapted to provide a rotational force. The motor 202 may include a shaft (not shown) such that the motor 202 may be adapted to provide the rotational force to the shaft. The shaft, in response to the rotational force, may be adapted to rotate.

In some aspects of the present disclosure, the motor 202 may be an alternating current (AC) motor and a direct current (DC) motor. The motor 202 may be a brushed motor, a brushless motor, a single-phase motor, a two-phase motor, and a three-phase motor. Aspects of the present disclosure are intended to include and/or otherwise cover any type of the motor 202, without deviating from the scope of the present disclosure.

The actuator 204 may be disposed on the base portion 106. The actuator 204 may be coupled to the motor 202. The actuator 204 may be adapted to rotate the base portion 106 in response to the rotational force provided by the motor 202. The base portion 106, upon rotation, may provide an enhanced visual effect to the decorative article 100.

The sound sensor 206 may be coupled to the illuminating sources 104. The sound sensor 206 may be configured to sense a first set of signals representing a first set of sounds. Upon sensing the first set of sounds, each illuminating source of the illuminating sources 104 facilitates one of, (i) illuminating of the corresponding branch of the branches 102 and (ii) darkening of the corresponding branch of the branches 102. Upon illuminating, the corresponding illuminating source of the illuminating sources 104 may be turned on such that the light traverses from the first end 108 to the second end 110. Upon darkening, the corresponding illuminating source of the illuminating sources 104 may be turned off such that the light does not traverse from the first end 108 to the second end 110.

In some aspects of the present disclosure, the first set of sounds may include one of, sounds produced by clapping gestures by a user and sounds produced by finger pinching gestures by the user. Aspects of the present disclosure are intended to include and/or otherwise cover any type of first set of sounds that may be produced by the user that may facilitate each illuminating source of the illuminating sources 104 to either illuminate the corresponding branch of the branches 102 or darken the corresponding branch of the branches 102, without deviating from the scope of the present disclosure.

The speaker 208 may be coupled to the sound sensor 206. The sound sensor 206 may be further configured to sense a second set of signals representing a second set of sounds. Upon sensing the second set of sounds, the speaker 208 produces musical chime.

In some aspects of the present disclosure, the second set of sounds may include one or more vocal sounds produced by the user. Aspects of the present disclosure are intended to include and/or otherwise cover any type of the second set of sounds that may be produced by the user, which in effect may facilitate the speaker 208 to produce the musical chime, without deviating from the scope of the present disclosure.

In some aspects of the present disclosure, the speaker 208 may play a song upon sensing the second set of sounds. Aspects of the present disclosure are intended to include and/or otherwise cover any sound produced by the speaker 208, without deviating from the scope of the present disclosure.

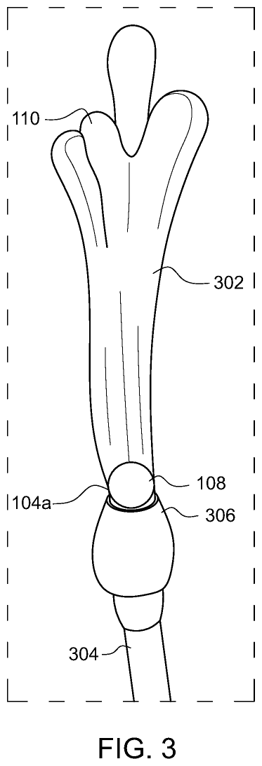

FIG. 3 illustrates a front view of a branch 302 of the decorative article 100 of FIG. 1, according to an aspect of the present disclosure. The branch 302 may be substantially similar, in terms of structural and functional aspects, to each branch of the branches 102. Therefore, for sake of brevity, not all the elements of each branch of the branches 102 are referred to in the branch 302 of FIG. 3.

The branch 302 may be coupled to a tube 304. Specifically, the branch 302 may be coupled to the tube 304 via a coupler 306. The coupler 306 may be of variable size that may be adapted to accommodate different branches of variable cross-sectional areas.

The branch 302 may be made up of a material, including but not limited to, a glass. Aspects of the present disclosure are intended to include and/or otherwise cover any type of known and later developed materials for the branch 302.

In some aspects of the present disclosure, the branch 302 may be a hot hand-formed piece of glass. In some other aspects of the present disclosure, the branch 302 may be a colorless branch. In some other aspects of the present disclosure, the branch 302 may be a colored branch. Aspects of the present disclosure are intended to include and/or otherwise cover any color that may be applied on the branch 302, without deviating from the scope of the present disclosure.

In some aspects of the present disclosure, the tube 304 may act like one of, a stand, a base, and a pedestal that may be adapted to hold the branch 302. Aspects of the present disclosure are intended to include and/or otherwise cover any kind of known and later developed support surface that may be adapted to hold the branch 302, without deviating from the scope of the present disclosure.

The illuminating source 104a may be disposed at the first end 108. The illuminating source 104a may be adapted to illuminate the branch 302. Specifically, upon illumination, a light traverse from the first end 108 to the second end 110. The illuminating source 104a may be adapted to illuminate the branch 302 with different colors. Specifically, the branch 302 may be illuminated with assorted colors such that the color of the branch 302 changes after a predefined interval of time.

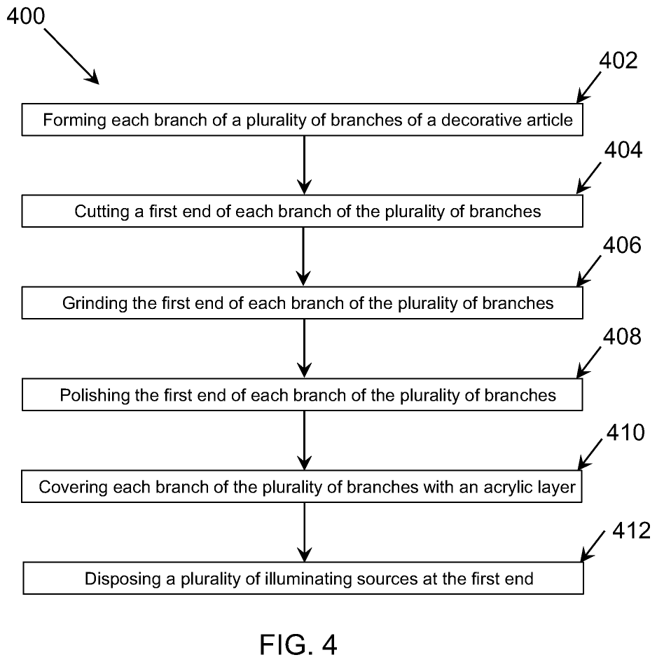

FIG. 4 illustrates a flowchart depicting a method 400 for manufacturing the decorative article 100 of FIG. 1, according to an aspect of the present disclosure. The flowchart may include the following steps for manufacturing the decorative article 100 of FIG. 1.

At step 402, forming each branch of the branches 102 such that each branch of the branches 102 may include the first end 108. Specifically, each branch of the branches 102 may be hot hand-formed. Each branch of the branches 102 may be made up of a material, including but not limited to, a glass. Aspects of the present disclosure are intended to include and/or otherwise cover any type of known and later developed materials for each branch of the branches 102, without deviating from the scope of the present disclosure. In some aspects of the present disclosure, each branch of the branches 102 may be formed by heat/mass/gravity. Specifically, gravity may pull down each branch of the branches 102 during formation. Excess pulling down of each branch of the branches 102 may be prevented by way of applying air pressure in front of each branch of the branches 102. The air pressure may be applied by a hose that may be positioned in front of each branch of the branches 102. The air hose may further be adapted to take out the heat from each branch of the branches 102. The air may be preferred to prevent excess pulling down and to remove heat from each branch of the branches 102 because, the air may not cause crimping in glass, during formation of each branch of the branches 102. The heat and mass may be proportional to dimension of each branch of the branches 102. For example, the higher the heat and the mass, the larger the size of each branch of the branches 102. In some aspects of the present disclosure, each branch of the branches 102 may be formed by hot treatment such that each branch of the branches 102 may be cooled with air, upon the hot treatment.

At step 404, cutting the first end 108 of each branch of the branches 102. Specifically, the first end 108 of each branch of the branches 102 may be cut through with a diamond saw or a machine with a diamond blade. The saw or blade may be adapted to remove a desired portion from the first end 108 of each branch of the branches 102. In some aspects of the present disclosure, the first end 108 of each branch of the branches 102 may be cut by any sharp tool, without deviating from the scope of the present disclosure.

At step 406, grinding the first end 108 of each branch of the branches 102. Specifically, the first end 108 of each branch of the branches 102 may be ground by a diamond pad. Aspects of the present disclosure are intended to include and/or otherwise cover any type of grinding tool that may be adapted to grind the first end 108 of each branch of the branches 102, without deviating from the scope of the present disclosure.

At step 408, polishing the first end 108 of each branch of the branches 102.

Each branch of the branches 102 may be glued to the base portion 106. In some aspects of the present disclosure, the base portion 106 may be glued to a low iron plate glass. In some aspects of the present disclosure, the low iron plate glass may be used because the low iron plate glass may not expand and contract i.e., the low iron plate glass may have little chance of expansion and contraction. In other words, the low iron plate glass may not be affected by temperature or heat. In some aspects of the present disclosure, a layer of acrylic is poured on top of the low iron plate glass to further secure the elements, such as the branches 102 to the low iron plate glass.

At step 412, disposing the illuminating sources 104 at the first end 108. One illuminating source of the illuminating sources 104 is having a different color from another illuminating source of the illuminating sources 104. Each illuminating source of the illuminating sources 104 is adapted to illuminate corresponding branch of the branches 102. Specifically, upon illumination of each branch of the branches 102, a light may traverse from the first end 108 to the second end 110.

In some aspects, each illuminating source of the illuminating sources 104 may be a light emitting diode (LED).

In some aspects of the present disclosure, upon illuminating, the corresponding illuminating source of the illuminating sources 104 may be turned on such that the light traverse from the first end 108 to the second end 110. Upon darkening, the corresponding illuminating source of the illuminating sources 104 may be turned off such that the light does not traverse from the first end 108 to the second end 110.

It should be understood according to the preceding description of the present invention that the same is susceptible to changes, modifications, and adaptations and that the said changes, modifications, and adaptations fall within the scope of the appended claims.

What is claimed is:

1. A decorative article (100) comprising:
a plurality of branches (102a-102n) such that each branch of the plurality of branches (102a-102n) comprising a first end (108);
a plurality of illuminating sources (104a-104n) such that each illuminating source of the plurality of illuminating sources (104a-104n) is disposed at the first end (108), wherein one illuminating source of the plurality of illuminating sources (104a-104n) is having a different color from another illuminating source of the plurality of the illuminating sources (104a-104n), wherein each illuminating source of the plurality of illuminating sources (104a-104n) is adapted to illuminate corresponding branch of the plurality of branches (102a-102n).

2. The decorative article (100) of claim 1, wherein each branch of the plurality of branches (102a-102n) further comprising a second end (110) that is disposed spaced apart from the first end (108) such that the second end (110) of a set of branches of the plurality of branches (102a-102n) is split into one or more nodes (112a-112c).

3. The decorative article (100) of claim 1, further comprising a base portion (106) such that the first end (108) is coupled to the base portion (106), wherein the base portion (106) is glued to a low iron plate glass.

4. The decorative article (100) of claim 1, further comprising:
a motor (202) adapted to provide a rotational force; and
an actuator (204) disposed on the base portion (106) and coupled to the motor (202) such that the actuator (204) rotates, in response to the rotational force provided by the motor (202), the base portion (106).

5. The decorative article (100) of claim 1, wherein each branch of the plurality of branches (102a-102n) has a length such that the length of one branch of the plurality of branches (102a-102n) is different from the length of another branch of the plurality of branches (102a-102n).

6. The decorative article (100) of claim 2, wherein upon illumination of each branch of the plurality of branches (102a-102n), light traverse from the first end (108) to the second end (110).

7. The decorative article (100) of claim 1, wherein the decorative article (100) is a waterless fountain.

8. The decorative article (100) of claim 1, wherein each branch of the plurality of branches (102a-102n) is made up of a freeform glass.

9. The decorative article (100) of claim 1, wherein each illuminating source of the plurality of illuminating sources (104a-104n) is a light emitting diode (LED).

10. The decorative article (100) of claim 1, further comprising a sound sensor (206) that is coupled to the plurality of illuminating sources (104a-104n) and configured to sense a first set of signals representing a first set of sounds, wherein upon sensing the first set of sounds, each illuminating source of the plurality of illuminating sources (104a-104n) facilitates one of (i) illuminating of the corresponding branch of the plurality of branches (102a-102n) and (ii) darkening of the corresponding branch of the plurality of branches (102a-102n).

11. The decorative article (100) of claim 10, further comprising a speaker (208) that is coupled to the sound sensor (206) such that the sound sensor (206) is configured to sense a second set of signals representing a second set of sounds, wherein upon sensing the second set of sounds, the speaker (208) produces musical chime.

12. The decorative article (100) of claim 10, wherein the first set of sounds comprise one of, sounds produced by clapping gestures by a user and sounds produced by finger pinching gestures by the user.

13. The decorative article (100) of claim 12, wherein the second set of sounds comprise one or more vocal sounds produced by the user.

14. A method (400) for manufacturing a decorative article (100), the method (400) comprising:
forming (402) each branch of the plurality of branches (102a-102n) such that each branch of the plurality of branches (102a-102n) comprising a first end (108);
cutting (404) the first end (108) of each branch of the plurality of branches (102a-102n);
grinding (406) the first end (108) of each branch of the plurality of branches (102a-102n);
polishing (408) the first end (108) of each branch of the plurality of branches (102a-102n); and
disposing (412) a plurality of illuminating sources (104a-104n) at the first end (108), wherein one illuminating source of the plurality of illuminating sources (104a-104n) is having a different color from another illuminating source of the plurality of the illuminating sources (104a-104n), wherein each illuminating source of the plurality of illuminating sources (104a-104n) is adapted to illuminate corresponding branch of the plurality of branches (102a-102n).
